(19) United States
(12) Patent Application Publication
(10) Pub. No.: US 2025/0322497 A1
(43) Pub. Date: Oct. 16, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Eito SAKAKIMA, Kanagawa (JP)

(21) Appl. No.: 19/170,292

(22) Filed: Apr. 4, 2025

(30) Foreign Application Priority Data
Apr. 10, 2024 (JP) 2024-063214

(51) Int. Cl. G06T 5/50; G06T 7/194; G06T 17/00

(52) U.S. Cl. CPC G06T 5/50; G06T 7/194; G06T 17/00; G06T 2207/20221

(57) ABSTRACT

A background image is suitably updated even in a case where a target object is motionless. An image processing apparatus according to the present disclosure obtains data on an input image, data on a background image used to extract a foreground region from the input image, and data on a three-dimensional model generated based on the foreground region extracted from the input image, and updates the background image based on the input image and the three-dimensional model.

This application claims priority to Japanese Patent Application No. 2024-063214, filed on Apr. 10, 2024, which is hereby incorporated by reference wherein in its entirety.

### BACKGROUND

### Field

The present disclosure relates to a technique of extracting a foreground region from an image.

### Description of the Related Art

There is a technique of extracting a foreground region from an image by analyzing the image (hereinafter referred to as “foreground extraction”). A well-known example of foreground extraction is background subtraction, which extracts, as a foreground region, a region of a target image detected differing from a background image. In background subtraction, accurate extraction of the foreground region requires a high-precision background image. Japanese Patent Laid-Open No. 2021-163303 (hereinafter referred to as “Patent Literature 1”) discloses a technique of updating a background image based on a state of an object corresponding to a foreground region of an input image during a predetermined period.

### SUMMARY

However, according to the method of updating a background image disclosed in Patent Literature 1, in a case where the predetermined period is short, the object is sometimes motionless during the predetermine period and the background image is updated so that an image region corresponding to the object is included in the background image, with the result that the foreground region cannot be accurately extracted. Further, in a case where the predetermined period is long, the background image is occasionally not updated at a suitable timing and the foreground region cannot be accurately extracted.

Therefore, the present disclosure discloses a technique capable of suitably updating a background image even in a case where a target object is motionless.

An image processing apparatus according to the present disclosure comprises: one or more hardware processors; and one or more memories storing one or more programs configured to be executed by the one or more hardware processors, the one or more programs including instructions for: obtaining data on at least one input image; obtaining data on a background image used to extract a foreground region from the input image; obtaining data on at least one three-dimensional model generated based on the foreground region extracted from the input image; and updating the background image based on the input image and the three-dimensional model.

Further features of the present disclosure will become apparent from the following description of exemplary embodiments with reference to the attached drawings.

### BRIEF DESCRIPTION OF THE DRAWINGS

FIG. 1 is a block diagram showing an example of a configuration of an image processing system according to a first embodiment;

FIG. 2 is a block diagram showing an example of a hardware configuration of an image processing apparatus according to the first embodiment;

FIG. 3 is a block diagram showing an example of a functional configuration of the image processing apparatus according to the first embodiment;

FIG. 4 is a flowchart showing an example of a processing flow in the image processing apparatus according to the first embodiment;

FIG. 5 is a diagram for illustrating projection processing in an update unit according to the first embodiment;

FIG. 6 is a flowchart showing an example of a processing flow in the image processing apparatus according to a second embodiment;

FIG. 7 is a diagram for illustrating update processing of a background image in an update unit according to the second embodiment;

FIG. 8 is a block diagram showing an example of a functional configuration of an image processing apparatus according to a third embodiment;

FIG. 9 is a flowchart showing an example of a processing flow in the image processing apparatus according to the third embodiment; and

FIG. 10 is a diagram for illustrating projection processing in an update unit according to the third embodiment.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

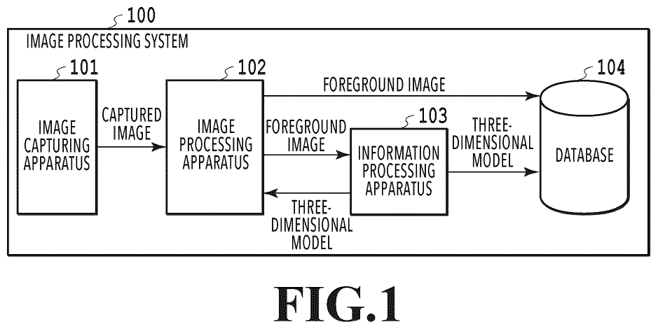

The first embodiment is explained below with reference to FIGS. 1 to 5. The first embodiment describes an aspect of using an obtained three-dimensional model indicating a three-dimensional shape of an object to specify the presence/absence of the three-dimensional model and thereby determine whether to update a background image corresponding to each image capturing apparatus.

### Configuration of Image Processing System

FIG. 1 is a block diagram showing an example of a configuration of an image processing system 100 according to the first embodiment. The image processing system 100 comprises an image capturing apparatus 101, an image processing apparatus 102, an information processing apparatus 103, and a database 104. The image processing system 100 is a system which generates a three-dimensional model corresponding to an object based on an image (hereinafter referred to as “captured image”) obtained through image capturing by the image capturing apparatus 101.

The image capturing apparatus 101 has a plurality of image capturing apparatuses each formed by a digital still camera, digital video camera, or the like. Each of the image capturing apparatuses belonging to the image capturing apparatus 101 captures an object in an image capturing region. Data on captured images obtained through image capturing by the image capturing apparatus 101, namely data on captured images obtained through image capturing by the image capturing apparatuses belonging to the image capturing apparatus 101, is transmitted to the image processing apparatus 102. In the present embodiment, it is assumed that each of the image capturing apparatuses belonging to the image capturing apparatus 101 captures a moving image and sequentially transmits, to the image processing apparatus 102, data on each frame constituting the moving image as data on a captured image.

The image processing apparatus 102 uses the background image to execute foreground/background separation processing of separating each captured image (frame) received from each of the image capturing apparatuses belonging to the image capturing apparatus 101 into a foreground region including a representation of the object and a background region not including a representation of the object. Data on foreground images showing foreground regions of respective captured images (frames) obtained by the separation are transmitted to the information processing apparatus 103 and the database 104.

The information processing apparatus 103 uses data on the foreground images received from the image processing apparatus 102 to generate a three-dimensional model corresponding to the object. Specifically, the information processing apparatus 103 generates a three-dimensional model corresponding to the object by, for example, executing well-known shape estimation processing of estimating a three-dimensional shape of the object such as a visual hull method. Data on the three-dimensional model thus generated is transmitted to the image processing apparatus 102 and the database 104.

The image processing apparatus 102 uses the three-dimensional model received from the information processing apparatus 103 to update the background image for use in the foreground/background separation processing. The database 104 receives the data on the three-dimensional model transmitted from the information processing apparatus 103 and the data on the foreground images transmitted from the image processing apparatus 102 and stores them in association with each other. The use of the data thus stored in the database 104 enables reproduction of a view from a position of an arbitrary virtual viewpoint.

### Hardware Configuration of Image Processing Apparatus

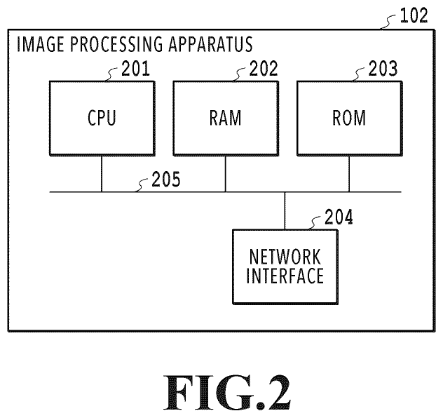

FIG. 2 is a block diagram showing an example of a hardware configuration of the image processing apparatus 102 according to the first embodiment. The image processing apparatus 102 comprises a central processing unit (CPU) 201, a random access memory (RAM) 202, a read only memory (ROM) 203, and a network interface (IF) 204. The units comprised in the image processing apparatus 102 as hardware elements are connected via a bus 205 so as to communicate with each other. The CPU 201 implements various functions of the image processing apparatus 102 by executing predetermined arithmetic processing or various programs using a control program stored in the ROM 203. Incidentally, the image processing apparatus 102 may have one or more pieces of dedicated hardware different from the CPU 201. In this case, the image processing apparatus 102 may execute at least part of the processing executed by the CPU 201 using the dedicated hardware. Examples of the dedicated hardware include an application-specific integrated circuit (ASIC), a field-programmable gate array (FPGA), and a digital signal processor (DSP).

The RAM 202 operates as main memory of the CPU 201 and is used as a temporary storage area such as a work area of the CPU 201. The ROM 203 stores a boot program, a control program, various kinds of data such as parameters used for operation of the image processing apparatus 102, and the like. The network IF 204 is an interface used for communication between the image processing apparatus 102 and an external device. For example, the network IF 204 is connected to a wired network such as a local area network (LAN). The image processing apparatus 102 transmits/receives various kinds of information to/from an external device via the network IF 204.

### Functional Configuration of Image Processing Apparatus

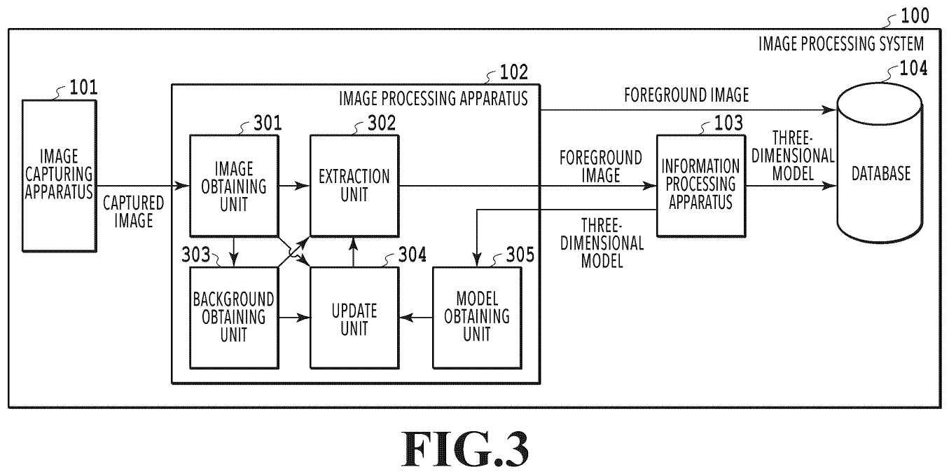

FIG. 3 is a block diagram showing an example of a functional configuration of the image processing apparatus 102 according to the first embodiment. The image processing apparatus 102 comprises an image obtaining unit 301, an extraction unit 302, a background obtaining unit 303, an update unit 304, and a model obtaining unit 305. The units comprised in the image processing apparatus 102 as functional elements are implemented by the CPU 201 executing a program stored in the ROM 203 using the RAM 202 as work memory. It should be noted that not all of the following processes necessarily have to be executed by the CPU 201 and the image processing apparatus 102 may be configured so that one or more processing circuits other than the CPU 201 execute part or all of the processes.

The image obtaining unit 301 obtains data on captured images (frames) obtained through image capturing by the image capturing apparatuses belonging to the image capturing apparatus 101 from the image capturing apparatus 101 as data on input images. The data on input images obtained by the image obtaining unit 301 is transmitted to the extraction unit 302, the background obtaining unit 303, and the update unit 304. Incidentally, although the present embodiment is based on the assumption that the image obtaining unit 301 obtains the data on captured images directly from the image capturing apparatus 101, a source from which the image obtaining unit 301 obtains the data on captured images is not limited to the image capturing apparatus 101. For example, the image obtaining unit 301 may obtain the data on captured images from an external device other than the image capturing apparatus 101 such as a storage device not shown in FIG. 1.

The background obtaining unit 303 receives the data on the input images transmitted from the image obtaining unit 301 and obtains data on a background image based on the received input images. Specifically, the background obtaining unit 303 obtains the data on the background image by, for example, generating a background image based on two or more input images different from one another in image capturing time on the assumption that pixels with pixel values unchanged or changed little for a predetermined period are pixels corresponding to a background. The background obtaining unit 303 may obtain, as the data on the background image, data on a captured image obtained by capturing in advance the image capturing region of the image capturing apparatus 101 with no object. In this case, for example, the data on the background image is prestored in the ROM 203 or the like and the background obtaining unit 303 obtains the data on the background image by reading the data on the background image prestored in the ROM 203 or the like. In a case where the update unit 304 has updated the background image, the background obtaining unit 303 obtains data on the background image updated by the update unit 304 (hereinafter referred to as “updated background image”) as the data on the background image. The data on the background image obtained by the background obtaining unit 303 is transmitted to the extraction unit 302 and the update unit 304.

The extraction unit 302 receives the data on the input images transmitted from the image obtaining unit 301 and the data on the background image transmitted from the background obtaining unit 303 and compares the received input images with the background image to extract foreground regions from the input images. Although there are various methods for comparing the received input image with the background image, for example, the extraction unit 302 may specify a pixel in which a difference in RGB value between corresponding pixels in the input image and the background image is equal to or greater than a threshold as a pixel included in a foreground region of the input image. The above method of comparison is just an example and the extraction unit 302 may use any method to compare the input image with the background image as long as the images can be compared by the method. Data on a foreground image indicating a foreground region corresponding to each of the input images extracted by the extraction unit 302 is transmitted to the information processing apparatus 103 and the database 104.

The model obtaining unit 305 obtains data on a three-dimensional model corresponding to the object in the image capturing region of the image capturing apparatus 101. Specifically, the model obtaining unit 305 obtains the data on the three-dimensional model by receiving the data on the three-dimensional model generated and transmitted by the information processing apparatus 103. The data on the three-dimensional model obtained by the model obtaining unit 305 is transmitted to the update unit 304.

The update unit 304 receives the data on the input images transmitted from the image obtaining unit 301, the data on the background image transmitted from the background obtaining unit 303, and the data on the three-dimensional model transmitted from the model obtaining unit 305. The update unit 304 uses the received input images and three-dimensional model to update the background image transmitted from the background obtaining unit 303. The data on the updated background image obtained through update processing by the update unit 304 is transmitted to the background obtaining unit 303 and the extraction unit 302.

In a case where the update unit 304 has updated the background image, the extraction unit 302 uses the data on the updated background image to extract a foreground region from the input image. Specifically, in this case, the extraction unit 302 extracts a foreground region from the input image by comparing the data on the input image received from the image obtaining unit 301 with the data on the updated background image received from the background obtaining unit 303. The data on the foreground image indicating the foreground region corresponding to each input image extracted by the extraction unit 302 is transmitted to the information processing apparatus 103 and the database 104.

### Operation of Image Processing Apparatus

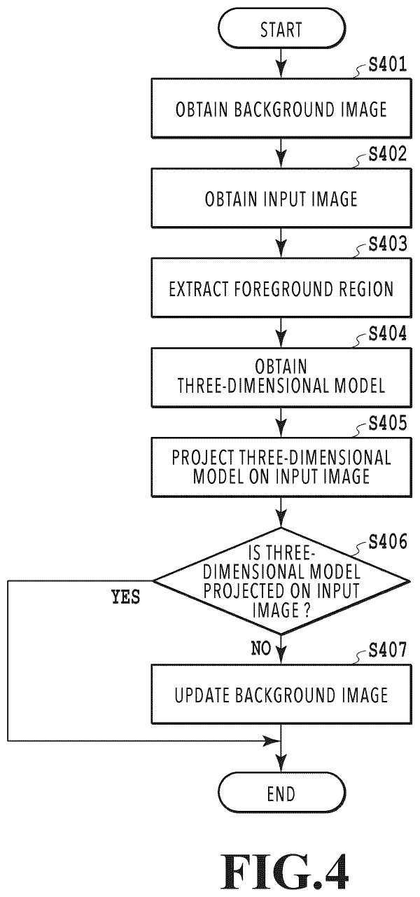

FIG. 4 is a flowchart showing an example of a processing flow in the image processing apparatus 102 according to the first embodiment. For example, the processing of this flowchart is repeated each time data on a plurality of frames obtained through synchronous image capturing is input from the image capturing apparatuses belonging to the image capturing apparatus 101. Incidentally, the synchronous image capturing does not mean simultaneous processing but means image capturing after execution of synchronous processing. In other words, the synchronous image capturing does not need to be executed exactly at the same time and includes image capturing executed almost at the same time. Incidentally, each processing step is denoted by a reference numeral headed with “S.”

First, in S401, the background obtaining unit 303 obtains the data on the background image. Here, in a case where the update unit 304 has updated the background image, the background obtaining unit 303 obtains data on the updated background image as the data on the background image. That is, the background obtaining unit 303 obtains data on the latest background image. The data on the background image obtained by the background obtaining unit 303 is transmitted to the extraction unit 302 and the update unit 304. Next, in S402, the image obtaining unit 301 obtains the data on the captured images from each of the image capturing apparatuses belonging to the image capturing apparatus 101 as data on input images. The data on the input images obtained in S401 is transmitted to the extraction unit 302, the background obtaining unit 303, and the update unit 304.

Next, in S403, the extraction unit 302 extracts a foreground region from each input image by comparing the input image and background image corresponding to each other based on the data on the input image obtained in S402 and the data on the background image obtained in S401. The data on the foreground image indicating the foreground region corresponding to each input image extracted in S403 is transmitted to the information processing apparatus 103. The information processing apparatus 103 receives the data on the foreground image corresponding to each input image transmitted in S403 and generates a three-dimensional model corresponding to the object. Incidentally, although the present embodiment is based on the assumption that the information processing apparatus 103 prestores information such as camera parameters necessary for generation of the three-dimensional model, the information processing apparatus 103 may receive the information from the image processing apparatus 102 or the image capturing apparatus 101 as appropriate. The data on the three-dimensional model generated in the information processing apparatus 103 is transmitted to the image processing apparatus 102.

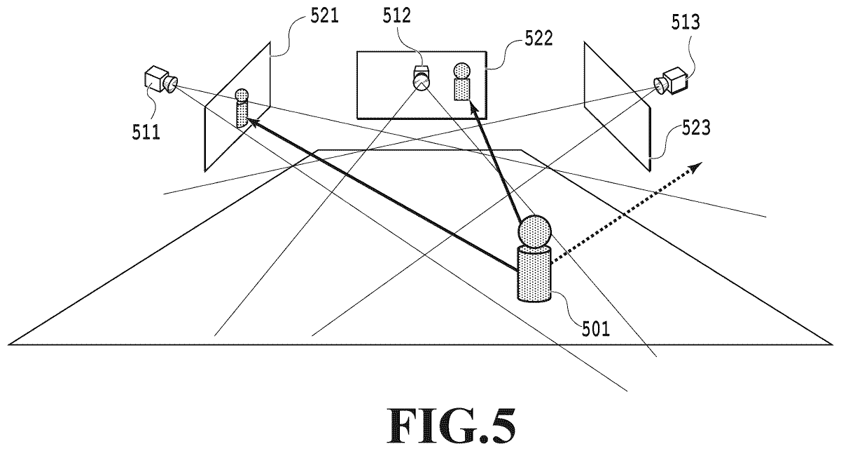

Next, in S404, the model obtaining unit 305 obtains the data on the three-dimensional model generated in the information processing apparatus 103. The data on the three-dimensional model obtained in S404 is transmitted to the update unit 304. Next, in S405, the update unit 304 projects the three-dimensional model obtained in S404 on each input image and specifies the state of projection of the three-dimensional model on each input image. The processing of S405 is described below with reference to FIG. 5.

FIG. 5 is a diagram for illustrating projection processing in the update unit 304 according to the first embodiment. FIG. 5 shows three image capturing apparatuses 511, 512, and 513 as an example of the image capturing apparatuses belonging to the image capturing apparatus 101. In FIG. 5, input images 521, 522, and 523 indicate captured images obtained through image capturing by the image capturing apparatuses 511, 512, and 513, respectively. The update unit 304 uses camera parameters of the respective image capturing apparatuses 511 to 513 to project a three-dimensional model 501 on the respective input images 521 to 523. As illustrated in FIG. 5, the three-dimensional model 501 is projected on the input images 521 and 522 but is not projected on the input image 523. Incidentally, although it is assumed that the camera parameters of the respective image capturing apparatuses 511 to 513 are prestored in the update unit 304, the update unit 304 may receive the camera parameters from the image capturing apparatus 101 as appropriate.

After S405, in S406, the update unit 304 determines whether the three-dimensional model is projected on each input image. In S407, the update unit 304 updates a background image corresponding to an image capturing apparatus which has captured an input image on which the three-dimensional model is not determined to be projected in S406. In the example of FIG. 5, since the three-dimensional model 501 is not projected on the input image 523, the update unit 304 updates in S407 a background image corresponding to the image capturing apparatus 513 which has captured the input image 523. Specifically, in S407, the update unit 304 updates the background image by replacing the background image with the input image. In the example of FIG. 5, the update unit 304 updates the background image corresponding to the image capturing apparatus 513 by replacing the background image corresponding to the image capturing apparatus 513 with the input image 523. Incidentally, the update unit 304 does not execute the processing of S407 for a background image corresponding to an image capturing apparatus which has captured the input image on which the three-dimensional model is determined to be projected in S406. After S407, the image processing apparatus 102 finishes the processing of the flowchart shown in FIG. 4. In a case where a plurality of captured images (frames) obtained through the next synchronous image capturing are input, the image processing apparatus 102 executes the processing of the flowchart again.

As described above, in the first embodiment, the image processing apparatus 102 is configured to use the three-dimensional model to determine whether or not the target object is reflected in each input image and to update the background image in a case where the target object is not reflected. According to the image processing apparatus 102 thus configured, the background image can be updated immediately in a case where the three-dimensional model is not projected on the input image. That is, the background image can be suitably updated even in a case where the target object is motionless for a predetermined period. As a result, according to the image processing apparatus 102, foreground/background separation processing can be executed with high precision.

### Second Embodiment

### Configuration of Image Processing System

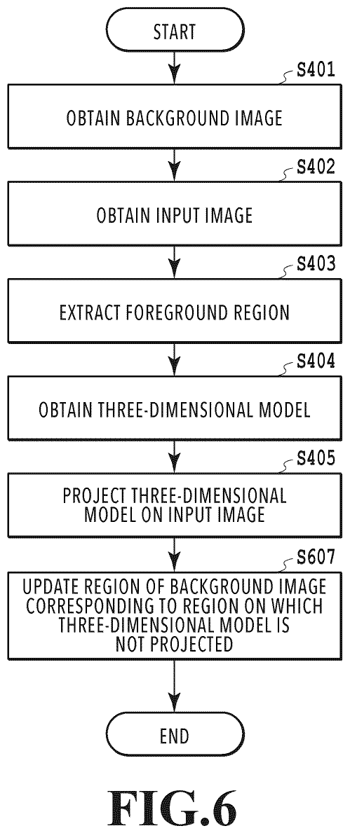

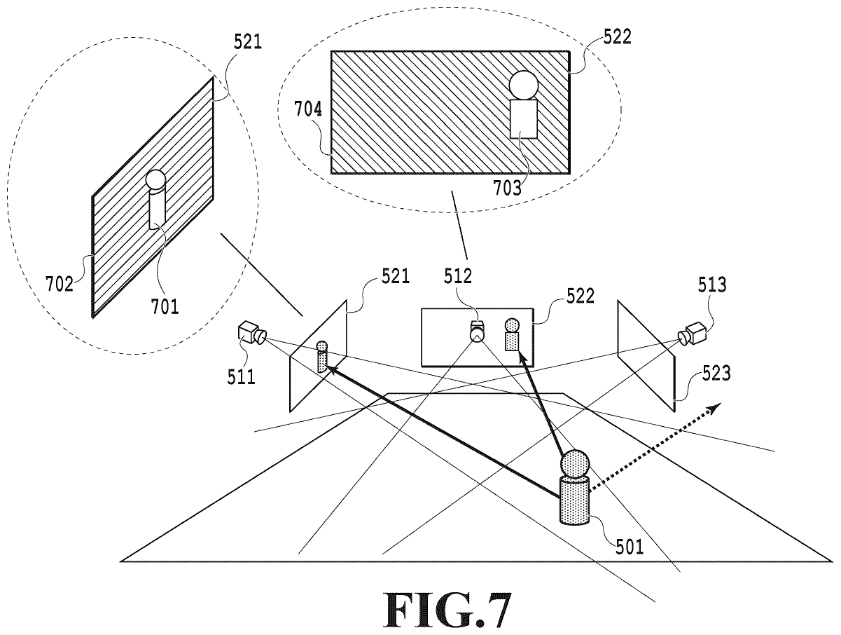

The second embodiment is explained below with reference to FIGS. 6 and 7. The second embodiment describes an aspect of using an obtained three-dimensional model to specify a region in which the three-dimensional model is absent and using information on the region to update a background image. Since the configuration of the image processing system 100 and the hardware configuration and functional configuration of the image processing apparatus 102 according to the second embodiment are the same as those of the first embodiment, only differences between the present embodiment and the first embodiment are described below.

### Operation of Image Processing Apparatus

FIG. 6 is a flowchart showing an example of a processing flow in the image processing apparatus 102 according to the second embodiment. For example, the processing of this flowchart is repeated each time data on a plurality of frames obtained through synchronous image capturing is input from the image capturing apparatuses belonging to the image capturing apparatus 101. Incidentally, the synchronous image capturing does not mean simultaneous processing but means image capturing after execution of synchronous processing. In other words, the synchronous image capturing does not need to be executed exactly at the same time and includes image capturing executed almost at the same time. Incidentally, a processing step shown in FIG. 6 identical to that shown in FIG. 4 is denoted by the same reference numeral as FIG. 4 and the description of the step is omitted. First, the image processing apparatus 102 executes the processing from S401 to S405. After S405, in S607, the update unit 304 updates the background image. Specifically, the update unit 304 uses a region of each input image on which the three-dimensional model is not projected to update a region of the background image corresponding to the region.

FIG. 7 is a diagram for illustrating update processing of a background image in the update unit 304 according to the second embodiment. In FIG. 7, the same element as that in FIG. 5 is denoted by the same reference numeral and the description of the element is omitted. In the input image 521 shown in FIG. 7, a region 701 is a region on which the three-dimensional model 501 is projected and a diagonally shaded region 702 is a region on which the three-dimensional model 501 is not projected. Similarly, in the input image 522 shown in FIG. 7, a region 703 is a region on which the three-dimensional model 501 is projected and a diagonally shaded region 704 is a region on which the three-dimensional model 501 is not projected.

The update unit 304 updates the background image corresponding to the image capturing apparatus 511 by replacing pixel values of a region of the background image corresponding to the image capturing apparatus 511 corresponding to the region 702 on which the three-dimensional model is not projected with pixel values of the region 702 of the input image 521. Similarly, the update unit 304 updates the background image corresponding to the image capturing apparatus 512 by replacing pixel values of a region of the background image corresponding to the image capturing apparatus 512 corresponding to the region 704 on which the three-dimensional model is not projected with pixel values of the region 704 of the input image 522. Incidentally, since the entire image region of the input image 523 is a region on which the three-dimensional model 501 is not projected, the update unit 304 updates the background image corresponding to the image capturing apparatus 513 by replacing it with the input image 523. After S607, the image processing apparatus 102 finishes the processing of the flowchart shown in FIG. 6. In a case where a plurality of captured images (frames) obtained through the next synchronous image capturing are input, the image processing apparatus 102 executes the processing of the flowchart again.

As described above, in the second embodiment, the image processing apparatus 102 is configured to use the three-dimensional model to specify a region in which a representation of a target object is present for the input image corresponding to each image capturing apparatus and to execute update processing for a region of a background image in which a representation of the object is absent. According to the image processing apparatus 102 thus configured, the background image can be immediately updated for a region of the input image on which the three-dimensional model is not projected. That is, the background image can be suitably updated even in a case where the target object is motionless. As a result, according to the image processing apparatus 102, foreground/background separation processing can be executed with high precision.

### Third Embodiment

### Configuration of Image Processing System

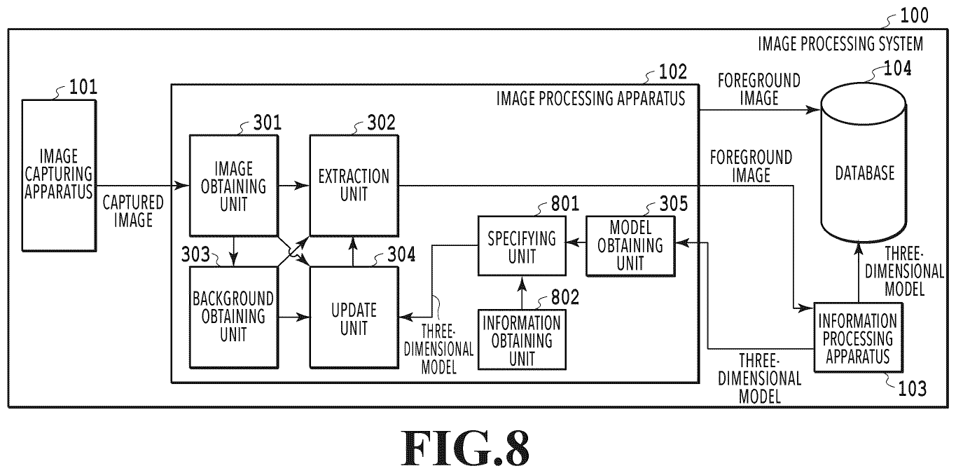

The third embodiment is explained below with reference to FIGS. 8 to 10. The third embodiment describes an aspect of using an obtained three-dimensional model to specify a region in which a three-dimensional model corresponding to a predetermined object is absent and using information on the region to update a background image. Since the configuration of the image processing system 100 and the hardware configuration of the image processing apparatus 102 according to the third embodiment are the same as those of the first and second embodiments, only differences between the present embodiment and the first and second embodiments are described below.

### Functional Configuration of Image Processing Apparatus

FIG. 8 is a block diagram showing an example of a functional configuration of the image processing apparatus 102 according to the third embodiment. The image processing apparatus 102 comprises the image obtaining unit 301, the extraction unit 302, the background obtaining unit 303, the update unit 304, the model obtaining unit 305, a specifying unit 801, and an information obtaining unit 802. The units comprised in the image processing apparatus 102 as functional elements are implemented by the CPU 201 executing a program stored in the ROM 203 using the RAM 202 as work memory. Incidentally, in FIG. 8, an element which performs the same processing as the functional element shown in FIG. 3 is denoted by the same reference numeral and the description of the element is omitted. In the present embodiment, data on the three-dimensional model obtained by the model obtaining unit 305 is transmitted to the specifying unit 801.

The information obtaining unit 802 obtains information (hereinafter referred to as “object information”) capable of specifying an object to be captured such as a feature amount of the object to be captured. In the present embodiment, it is assumed that the object information corresponding to the object to be captured is set by a user and stored in the ROM 203 or the like in advance. That is, the information obtaining unit 802 obtains the object information from the ROM 203 or the like by reading the object information stored in the ROM 203 or the like. The object information obtained by the information obtaining unit 802 is transmitted to the specifying unit 801.

The specifying unit 801 uses the object information received from the information obtaining unit 802 to specify a three-dimensional model corresponding to the object to be captured among the three-dimensional models received from the model obtaining unit 305. The specifying unit 801 transmits, to the update unit 304, data on the three-dimensional model specified as the three-dimensional model corresponding to the object to be captured among the three-dimensional models received from the model obtaining unit 305.

### Operation of Image Processing Apparatus

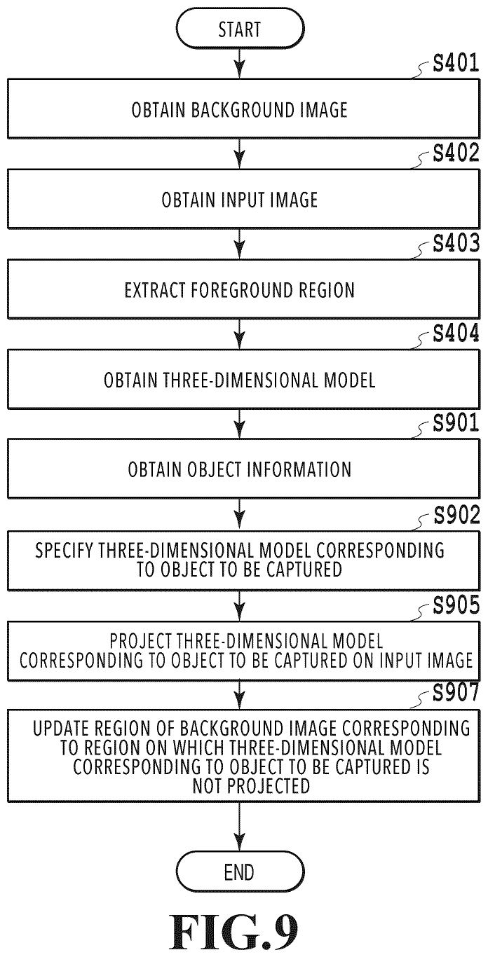

FIG. 9 is a flowchart showing an example of a processing flow in the image processing apparatus 102 according to the third embodiment. For example, the processing of this flowchart is repeated each time data on a plurality of frames obtained through synchronous image capturing is input from the image capturing apparatuses belonging to the image capturing apparatus 101. Incidentally, the synchronous image capturing does not mean simultaneous processing but means image capturing after execution of synchronous processing. In other words, the synchronous image capturing does not need to be executed exactly at the same time and includes image capturing executed almost at the same time. Incidentally, a processing step shown in FIG. 9 identical to that shown in FIG. 4 or 6 is denoted by the same reference numeral as FIG. 4 or 6 and the description of the step is omitted.

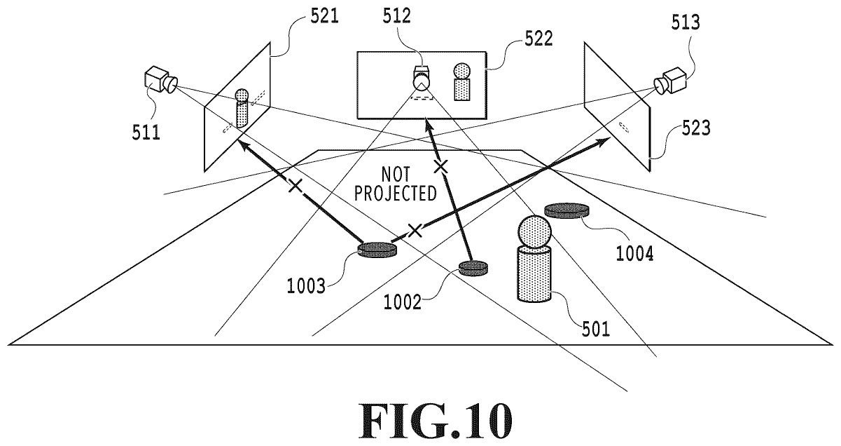

First, the image processing apparatus 102 executes the processing from S401 to S404. The data on the three-dimensional model obtained in S404 is transmitted to the specifying unit 801. After S404, in S901, the information obtaining unit 802 obtains the object information. The object information obtained in S901 is transmitted to the specifying unit 801. Next, in S902, the specifying unit 801 uses the object information obtained in S901 to specify whether each of one or more three-dimensional models obtained in S404 is a three-dimensional model corresponding to the object to be captured. Data on a three-dimensional model specified in S902 as a three-dimensional model corresponding to the object to be captured is transmitted to the update unit 304 and used for the processing in S905 and S907. Next, in S905, the update unit 304 projects the three-dimensional model specified in S902 as the three-dimensional model corresponding to the object to be captured on each input image and specifies a state of projection of the three-dimensional model on each input image. The processing of S905 is described below with reference to FIG. 10.

FIG. 10 is a diagram for illustrating projection processing in the update unit 304 according to the third embodiment. In FIG. 10, the same element as that in FIG. 5 or 7 is denoted by the same reference numeral and the description of the element is omitted. In FIG. 10, the three-dimensional model 501 is a three-dimensional model corresponding to the object to be captured and three-dimensional models 1002 to 1004 are three-dimensional models corresponding to objects other than the object to be captured. The three-dimensional models corresponding to objects other than the object to be captured such as the three-dimensional model 1002 are, for example, unintended three-dimensional models which have been extracted as foreground regions due to unintended dirt, unevenness, or the like on the ground and generated in the information processing apparatus 103. In S905, the update unit 304 projects only the three-dimensional model 501 corresponding to the object to be captured in S902 on the input image without projecting the other three-dimensional models 1002 to 1004 on the input image.

In the example shown in FIG. 10, for example, the object information includes a feature amount or the like of a natural person as the object to be captured. The use of such object information enables the specifying unit 801 to identify and specify the three-dimensional model 501 corresponding to the natural person and the three-dimensional models 1002 to 1004 corresponding to objects other than the natural person. The object information is not limited to the above information. For example, the object information may include information indicating a range of height of the object or the like. For example, in a case where the object to be captured is a natural person and an object to be excluded from the target to be captured is dirt, unevenness, or the like on the ground, it is only necessary to set information indicating a predetermined height such as one meter or more as the object information.

After S905, in S907, the update unit 304 updates the background image. Specifically, the update unit 304 uses a region of each input image on which the three-dimensional model corresponding to the object to be captured as specified in S905 is not projected to update a region of the background image corresponding to the region. Since the update processing for the background image in S907 is the same as that in S607, the detailed description of the processing is omitted. After S907, the image processing apparatus 102 finishes the processing of the flowchart shown in FIG. 9. In a case where a plurality of captured images (frames) obtained through the next synchronous image capturing are input, the image processing apparatus 102 executes the processing of the flowchart again.

As described above, in the third embodiment, the image processing apparatus 102 is configured to specify a three-dimensional model corresponding to the object to be captured in advance and uses the specified three-dimensional model to specify a region in which a representation of the object to be captured is present for the input image corresponding to each image capturing apparatus. Further, as described above, in the third embodiment, the image processing apparatus 102 is also configured to execute update processing for a region of the background image in which a representation of the object is absent. According to the image processing apparatus 102 thus configured, the background image can be immediately updated for a region of the input image on which the three-dimensional model corresponding to the object to be captured is not projected. As a result, according to the image processing apparatus 102, the background image can be suitably updated even in a case where the target object is motionless and foreground/background separation processing can be executed with high precision.

### Other Embodiments

In the above embodiments, for example, the image processing apparatus 102 has been described as comprising the extraction unit 302, which extracts the foreground region from the input image. However, the image processing apparatus 102 only has to obtain data on the foreground image. Accordingly, the extraction processing of the foreground region may be executed by an external device. Further, in the above embodiments, for example, the image processing system 100 has been described as comprising the information processing apparatus 103, which generates the three-dimensional model corresponding to the object. However, the three-dimensional model may be generated in the image processing apparatus 102. In this case, for example, the model obtaining unit 305 receives data on the foreground image transmitted from the extraction unit 302 and obtains data on the three-dimensional model by generating the three-dimensional model based on the received data on the foreground image.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, the background image can be suitably updated even in a case where a target object is motionless.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. An image processing apparatus comprising:
one or more hardware processors; and
one or more memories storing one or more programs configured to be executed by the one or more hardware processors, the one or more programs including instructions for:
obtaining data on at least one input image;
obtaining data on a background image used to extract a foreground region from the input image;
obtaining data on at least one three-dimensional model generated based on the foreground region extracted from the input image; and
updating the background image based on the input image and the three-dimensional model.

2. The image processing apparatus according to claim 1, wherein the one or more programs further include instructions for:
in a case where the three-dimensional model is projected on the input images, updating the background image by using the input image on which the three-dimensional model is not projected to replace the background image.

3. The image processing apparatus according to claim 1, wherein the one or more programs further include instructions for:
in a case where the three-dimensional model is projected on the input image, updating the background image by using a region of the input image on which the three-dimensional model is not projected to replace a region of the background image corresponding to the region.

4. The image processing apparatus according to claim 1, wherein the one or more programs further include instructions for:
obtaining object information concerning a target object;
specifying a target three-dimensional model corresponding to the target object from the three-dimensional models based on the object information; and
updating the background image based on the input image and the target three-dimensional model.

5. The image processing apparatus according to claim 4, wherein the one or more programs further include instructions for:
in a case where the target three-dimensional model is projected on the input images, updating the background image by using the input image on which the target three-dimensional model is not projected to replace the background image.

6. The image processing apparatus according to claim 4, wherein the one or more programs further include instructions for:
in a case where the target three-dimensional model is projected on the input image, updating the background image by using a region of the input image on which the target three-dimensional model is not projected to replace a region of the background image corresponding to the region.

7. The image processing apparatus according to claim 1, wherein the one or more programs further include instructions for:
obtaining data on an image obtained through image capturing by an image capturing apparatus as the data on the input image.

8. The image processing apparatus according to claim 7, wherein the one or more programs further include instructions for:
executing projection processing of the three-dimensional model on the input image based on a camera parameter of the image capturing apparatus.

9. The image processing apparatus according to claim 1, wherein the one or more programs further include instructions for:
extracting the foreground region from the input image using the background image.

10. The image processing apparatus according to claim 1, wherein the one or more programs further include instructions for:
obtaining the data on the three-dimensional model by generating the three-dimensional model based on the foreground region.

11. An image processing method comprising the steps of:
obtaining data on at least one input image;
obtaining data on a background image used to extract a foreground region from the input image;
obtaining data on at least one three-dimensional model generated based on the foreground region extracted from the input image; and
updating the background image based on the input image and the three-dimensional model.

12. A non-transitory computer readable storage medium storing a program for causing a computer to perform a control method of an image processing apparatus, the control method comprising the steps of:
obtaining data on at least one input image;
obtaining data on a background image used to extract a foreground region from the input image;
obtaining data on at least one three-dimensional model generated based on the foreground region extracted from the input image; and
updating the background image based on the input image and the three-dimensional model.
